(19) United States
(12) Patent Application Publication
(10) Pub. No.: US 2025/0362809 A1
(43) Pub. Date: Nov. 27, 2025

(54) MEMORY SYSTEM, HOST, OPERATION METHOD, AND DATA PROCESSING SYSTEM

(71) Applicant: YANGTZE MEMORY TECHNOLOGIES CO., LTD., Wuhan (CN)

(72) Inventor: Ganlin YE, Wuhan (CN)

(21) Appl. No.: 18/824,586

(22) Filed: Sep. 4, 2024

(30) Foreign Application Priority Data
May 21, 2024 (CN) 202410638311.4

(51) Int. Cl. G06F 3/06; G06F 12/1009

(52) U.S. Cl. CPC G06F 3/0613; G06F 3/0659; G06F 3/0679; G06F 12/1009

(57) ABSTRACT

According to one aspect of the present disclosure, a method of operating a memory system is provided. The method may include sending a logical-to-physical (L2P) mapping table in a first operation mode or a second operation mode. The first operation mode may include: sending first recommendation information. The first recommendation information may include at least one L2P mapping table. The second operation mode may include: sending a data input universal flash storage protocol information unit (UPIU) in response to a host performance booster (HPB) read buffer command. The data input UPIU may include at least two L2P mapping tables.

### CROSS-REFERENCE TO RELATED APPLICATIONS

This application claims the benefit of priority to Chinese Application No. 202410638311.4, filed on May 21, 2024, which is incorporated herein by reference in its entirety.

### TECHNICAL FIELD

Examples of the present disclosure relate to the technical field of memories, and particularly to a memory system, a host, an operation method, and a data processing system.

### BACKGROUND

When a Flash-based memory apparatus such as a Universal Flash Storage (UFS) performs operations related to data access, a logical address requested by an IO interface of a host needs to be translated into a physical address corresponding to a memory cell in a Flash, generating a Logical-to-Physical (L2P) mapping table. The L2P mapping table may be provided to the host by the UFS.

### SUMMARY

According to one aspect of the present disclosure, a method of operating a memory system is provided. The method may include sending a logical-to-physical (L2P) mapping table in a first operation mode or a second operation mode. The first operation mode may include: sending first recommendation information. The first recommendation information may include at least one L2P mapping table. The second operation mode may include: sending a data input universal flash storage protocol information unit (UPIU) in response to a host performance booster (HPB) read buffer command. The data input UPIU may include at least two L2P mapping tables.

In some implementations, the first recommendation information may include data information of at least one HPB region, and each HPB region corresponds to one L2P mapping table.

In some implementations, the first recommendation information may include an extended data segment and a first particular data segment, the extended data segment may be configured to store the L2P mapping table, and the first particular data segment may be configured to store the data information of the HPB region.

In some implementations, the extended data segment may include an allocation length, the first recommendation information may further include a total extended data segment length, the allocation length may be related to the total extended data segment length, and the total extended data segment length may be related to a number of the HPB regions.

In some implementations, the data input UPIU may include data information of at least two HPB regions, and each HPB region may correspond to one L2P mapping table.

In some implementations, the data input UPIU may include extended data segment information and second particular data segment information. In some implementations, the second particular data segment information may be configured to store data information of the first one among the at least two HPB regions. In some implementations, the extended data segment information may be configured to store data information of the HPB regions other than a first HPB region.

In some implementations, the extended data segment information may include an allocation length. In some implementations, the data input UPIU may further include a total extended data segment length. In some implementations, the allocation length may be related to the total extended data segment length, and the total extended data segment length may be related to a number of the HPB regions.

In some implementations, before the sending the data input UPIU in response to the HPB read buffer command, the method may further include sending at least one piece of second recommendation information. In some implementations, each piece of second recommendation information may include data information of at least one HPB region.

In some implementations, the sending the L2P mapping table in the first operation mode or the second operation mode may include acquiring an internal storage situation of a target device. In some implementations, the sending the L2P mapping table in the first operation mode or the second operation mode may include determining to send the L2P mapping table in the first operation mode or the second operation mode according to the acquired internal storage situation of the target device.

In some implementations, the determining to send the L2P mapping table in the first operation mode or the second operation mode according to the acquired internal storage situation of the target device may include, when an internal storage usage of the target device is greater than a first threshold, sending the L2P mapping table in the first operation mode. In some implementations, the determining to send the L2P mapping table in the first operation mode or the second operation mode according to the acquired internal storage situation of the target device may include, when the internal storage usage of the target device is less than or equal to the first threshold, sending the L2P mapping table in the second operation mode.

According to another aspect of the present disclosure, a method of operating a host is provided. The method may include receiving at least one piece of first recommendation information or second recommendation information. The method may include, when receiving the first recommendation information, decoding the first recommendation information to obtain at least one L2P mapping table. The method may include, when receiving the second recommendation information, sending an HPB read buffer command. The HPB read buffer command may include data information of at least two HPB regions.

In some implementations, after the sending the HPB read buffer command, the method may further include receiving a data input UPIU sent by a target device in response to the HPB read buffer command. In some implementations, after the sending the HPB read buffer command, the method may further include decoding the data input UPIU to obtain at least two L2P mapping tables. In some implementations, each L2P mapping table may correspond to one HPB region.

In some implementations, the HPB read buffer command may include extended data segment information and second particular data segment information. In some implementations, the second particular data segment information may be configured to store data information of the first one among the at least two HPB regions. In some implementations, the extended data segment information may be configured to store data information of the HPB regions other than a first HPB region.

In some implementations, the extended data segment information may include an allocation length, and the allocation length is related to a number of the HPB regions.

In some implementations, before receiving at least one piece of the first recommendation information or the second recommendation information, the method may further include sending an internal storage situation to a target device.

According to a further aspect of the present disclosure, a memory system is provided. The memory system may include a memory device and a controller. The controller may be configured to perform a method of operating a memory system. The method may include sending a logical-to-physical (L2P) mapping table in a first operation mode or a second operation mode. The first operation mode may include: sending first recommendation information. The first recommendation information may include at least one L2P mapping table. The second operation mode may include: sending a data input universal flash storage protocol information unit (UPIU) in response to a host performance booster (HPB) read buffer command. The data input UPIU may include at least two L2P mapping tables.

According to still another aspect of the present disclosure, a host is provided. The host may be configured to perform operations. The operations may include receiving one or more of first recommendation information or second recommendation information. The operations may include, when receiving the first recommendation information, decoding the first recommendation information to obtain at least one L2P mapping table. The operations may include, when receiving the second recommendation information, sending an HPB read buffer command. The HPB read buffer command may include data information of at least two HPB regions.

According to still a further aspect of the present disclosure. A data processing system is provided. The data processing system may include a host and a memory system. The memory system may be configured to send, to the host, an L2P mapping table in a first operation mode or a second operation mode. In the first operation mode, the memory system may be configured to send first recommendation information to the host. The first recommendation information may include at least one L2P mapping table. In the second operation mode, the memory system may be configured to, in response to an HPB read buffer command sent by the host, send a data input UPIU to the host. The data input UPIU may include at least two L2P mapping tables.

In some implementations, the memory system may be further configured to send at least one piece of second recommendation information to the host. In some implementations, each piece of second recommendation information may include data information of at least one HPB region. In some implementations, the host may be configured to decode the first recommendation information to obtain at least one L2P mapping table when receiving the first recommendation information. In some implementations, the host may be configured to send the HPB read buffer command to the memory system when receiving the second recommendation information. In some implementations, the HPB read buffer command may include data information of at least two HPB regions.

In some implementations, the host may be further configured to send an internal storage situation to the memory system. In some implementations, the memory system may be further configured to determine, according to the internal storage situation, to send, to the host, the L2P mapping table in the first operation mode or the second operation mode.

### BRIEF DESCRIPTION OF THE DRAWINGS

FIG. 1 is a schematic diagram of performing HPB data communication between a host and a memory system in one example;

FIG. 2 is a flow diagram of an operation method of a memory system provided by examples of the present disclosure;

FIG. 3 is a schematic diagram of performing HPB data communication between a memory system and a host in a first operation mode in examples of the present disclosure;

FIG. 4 is a schematic diagram of performing HPB data communication between a memory system and a host in a second operation mode in one example of the present disclosure;

FIG. 5 is a schematic diagram of performing HPB data communication between a memory system and a host in a second operation mode in another example of the present disclosure;

FIG. 6 is a UPIU format of first recommendation information provided by examples of the present disclosure;

FIG. 7 is a format of an EHS header field provided by examples of the present disclosure;

FIG. 8 is a UPIU format of recommendation information provided in one example;

FIG. 9 is a UPIU format of an HPB read buffer command provided by examples of the present disclosure;

FIG. 10 is an L2P mapping table in a data input UPIU provided by examples of the present disclosure;

FIG. 11 is a block diagram of a memory system provided by examples of the present disclosure;

FIG. 12 is a block diagram of a host provided by examples of the present disclosure; and

FIG. 13 is a block diagram of a data processing system provided by examples of the present disclosure.

### DETAILED DESCRIPTION

The technical solutions in implementations of the present disclosure will be described below clearly and completely in conjunction with the implementations and the drawings of the present disclosure. Apparently, the implementations described are only part, but not all, of the implementations of the present disclosure. All other implementations obtained by those of ordinary skills in the art based on the implementations in the present disclosure without creative work shall fall within the scope of protection of the present disclosure.

In the description below, many particular details are presented to provide a more thorough understanding of the present disclosure. However, it is apparent to those skilled in the art that the present disclosure may be implemented without one or more of these details. In other examples, in order to avoid confusion with the present disclosure, some technical features well-known in the field are not described. That is, not all the features of the actual examples are described here, and well-known functions and structures are not described in detail.

In the drawings, the sizes of a layer, a region, and an element and their relative sizes may be exaggerated for clarity. Like reference numerals denote like elements throughout the specification.

It is to be understood that when an element or a layer is referred to as being “on”, “adjacent to”, “connected to”, or “coupled to” other elements or layers, it may be directly on, adjacent to, connected to, or coupled to the other elements or layers, or intervening elements or layers may be present. In contrast, when an element is referred to as being “directly on”, “immediately adjacent to”, “directly connected to”, or “directly coupled to” other elements or layers, no intervening elements or layers are present. It is to be understood that, although terms first, second, third and the like may be used to describe various elements, components, regions, layers and/or sections, these elements, components, regions, layers and/or sections should not be limited by these terms. These terms are only used to distinguish one element, component, region, layer or portion from another element, component, region, layer or portion. Thus, a first element, component, region, layer or portion discussed below may be represented as a second element, component, region, layer or portion, without departing from the teachings of the present disclosure. When the second element, component, region, layer or portion is discussed, it does not mean that the first element, component, region, layer or portion is necessarily present in the present disclosure.

The spatially relative terms, such as “beneath”, “below”, “lower”, “under”, “above”, “upper”, and the like, may be used herein for ease of description to describe one element or feature's relationship to other elements or features as illustrated in the figures. It is to be understood that, in addition to the orientation depicted in the figures, the spatially relative terms are intended to further encompass different orientations of a device in use or operation. For example, if the device in the drawings is turned over, then the elements or the features described as “below” or “under” or “beneath” other elements may be oriented “on” the other elements or features. Thus, the example terms, “below” and “beneath”, may comprise both upper and lower orientations. The device may be orientated otherwise (rotated by 90 degrees or other orientations), and the spatially descriptive terms used herein are interpreted accordingly.

The terms used herein are only intended to describe the examples, and are not used as limitations of the present disclosure. As used herein, unless otherwise indicated expressly in the context, “a”, “an” and “the” in a singular form are also intended to comprise a plural form. It should also be understood that terms “consist of” and/or “comprise”, when used in this specification, determine the presence of the described features, integers, steps, operations, elements and/or components, but do not preclude the presence or addition of one or more of other features, integers, steps, operations, elements, components, and/or groups. As used herein, the term “and/or” comprises any or all combinations of the listed relevant items.

In order to understand the present disclosure thoroughly, detailed operations and detailed structures will be proposed in the following description to set forth the technical solution of the present disclosure. Detailed descriptions of the examples of the present disclosure are as follows. However, the present disclosure may also have other implementations in addition to these detailed descriptions.

In order to improve a random read capability, a UFS protocol is introduced in a Host Performance Booster (HPB), and the HPB may utilize a internal storage of a host as a buffer region for a UFS apparatus to load data of an L2P mapping table. However, in a UFS HPB 2.0 protocol, every time the host sends one HPB read buffer command to a memory apparatus, the host can only read the L2P mapping table corresponding to one HPB region in the memory apparatus. If the L2P mapping tables corresponding to the plurality of HPB regions are about to be read, the plurality of corresponding HPB read buffer commands need to be sent. As a result, the host needs to be interacted with a memory system for a plurality of times, resulting in low read efficiency of the L2P mapping table.

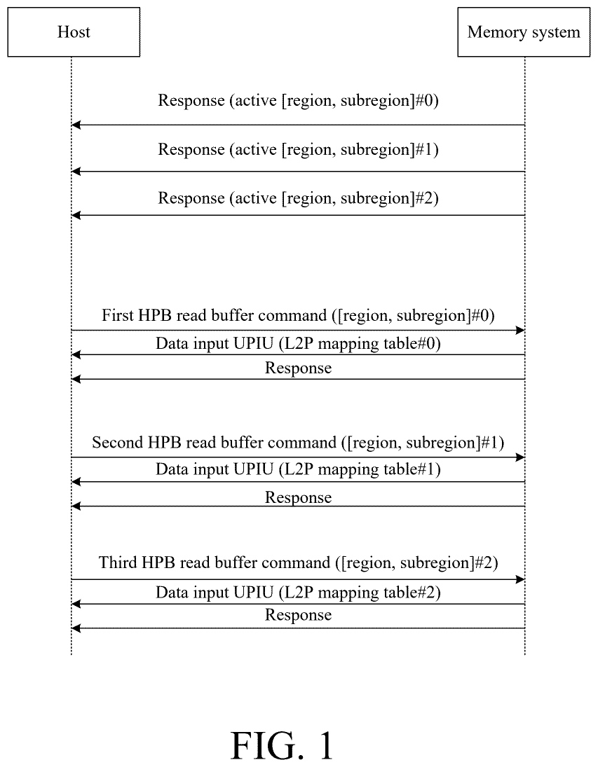

FIG. 1 is a schematic diagram of performing HPB data communication between a host and a memory system in one example.

As shown in FIG. 1, the memory system sends, to the host, responses of a plurality of pieces of recommendation information carrying data information of the HPB regions. In an example, the memory system sends three pieces of recommendation information sequentially to the host, and each piece of recommendation information carries data information of one HPB region that is confirmed to be activated. Three HPB regions are respectively denoted as [region, subregion]#0 (i.e., active HPB region+subregion #0), [region, subregion]#1 (i.e., active HPB region+subregion #1), and [region, subregion]#2 (i.e., active HPB region+subregion #2).

After the host receives the recommendation information, when the host is in an idle state, the host may send the HPB read buffer command (HPB READ BUFFER) to the memory system. In an example, the host sends a first HPB read buffer command to the memory system; the first HPB read buffer command includes data information of the [region, subregion]#0; and the first HPB read buffer command is configured to read an L2P mapping table #0 corresponding to the [region, subregion]#0. Then, the memory system sends, in response to the first HPB read buffer command sent by the host, the L2P mapping table #0 corresponding to the [region, subregion]#0 to the host through a data input UPIU (DATA IN UPIU). In this case, the host acquires the L2P mapping table #0 corresponding to the [region, subregion]#0. It can be understood that, if the host is about to read the L2P mapping tables corresponding to the plurality of HPB regions, the host needs to send a corresponding number of the HPB read buffer commands to the memory system. Referring to FIG. 1, the host sequentially sends a second HPB read buffer command and a third HPB read buffer command to the memory system. The second HPB read buffer command includes data information of the [region, subregion]#1; and the second HPB read buffer command is configured to read an L2P mapping table #1 corresponding to the [region, subregion]#1. The memory system sends, in response to the second HPB read buffer command sent by the host, the L2P mapping table #1 corresponding to the [region, subregion]#1 to the host through the data input UPIU. The third HPB read buffer command includes data information of the [region, subregion]#2; and the third HPB read buffer command is configured to read an L2P mapping table #2 corresponding to the [region, subregion]#2. The memory system sends, in response to the third HPB read buffer command sent by the host, the L2P mapping table #2 corresponding to the [region, subregion]#2 to the host through the data input UPIU. In this case, the host acquires the L2P mapping tables corresponding to three HPB regions in total, which respectively are the L2P mapping table #0 corresponding to the [region, subregion]#0, the L2P mapping table #1 corresponding to the [region, subregion]#1, and the L2P mapping table #2 corresponding to the [region, subregion]#2. However, in a process of performing HPB data communication between the host and the memory system, due to frequent interactions between the host and the memory system, the efficiency of the host reading the L2P mapping table is relatively low, resulting in poor random read performance.

Therefore, there is an unmet need for a method of operating a memory system that improves random read performance.

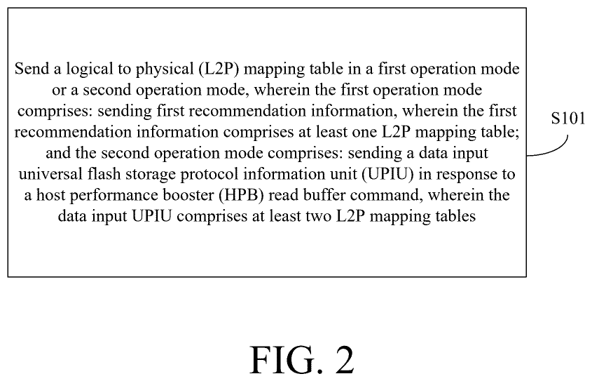

FIG. 2 is a flow diagram of an operation method of a memory system provided by examples of the present disclosure.

As shown in FIG. 2, examples of the present disclosure provide a method of operating a memory system. The method may include, e.g., operation S101.

At operation S101, a logical-to-physical (L2P) mapping table may be sent in a first operation mode or a second operation mode. The first operation mode includes: sending first recommendation information. The first recommendation information includes at least one L2P mapping table. The second operation mode includes: sending a data input universal flash storage protocol information unit (UPIU) in response to a host performance booster (HPB) read buffer command. The data input UPIU includes at least two L2P mapping tables.

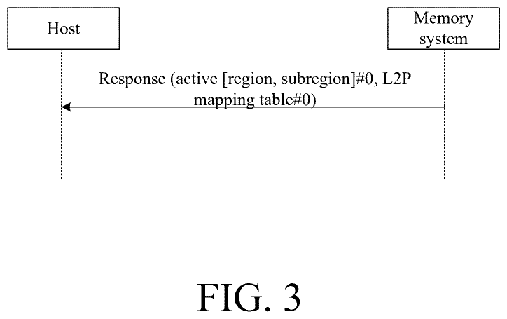

FIG. 3 is a schematic diagram of performing HPB data communication between a memory system and a host in a first operation mode in examples of the present disclosure.

As shown in FIG. 3, in the first operation mode, the memory system sends, to the host, a response of the first recommendation information including at least one L2P mapping table. In an example, the memory system sends, to the host, the first recommendation information including the L2P mapping table #0 corresponding to the [region, subregion]#0.

In other examples of the present disclosure, the memory system may send, to the host, the first recommendation information of the L2P mapping table #0 and the L2P mapping table #1 respectively corresponding to the [region, subregion]#0 and the [region, subregion]#1. Therefore, the number of interactions between the host and the memory system in the process of reading the L2P mapping table is effectively reduced. That is, a process that sends the HPB read buffer command to the memory system after the host receives the first recommendation information and a process that the memory system sends the L2P mapping table to the host in response to the HPB read buffer command are omitted, such that read efficiency is effectively improved.

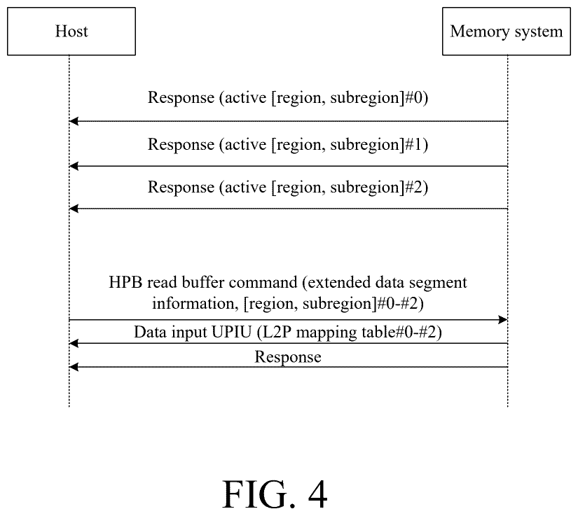

FIG. 4 is a schematic diagram of performing HPB data communication between a memory system and a host in a second operation mode in one example of the present disclosure.

As shown in FIG. 4, in the second operation mode, the memory system sends, in response to the HPB read buffer command sent by the host, the data input UPIU including at least two L2P mapping tables to the host. In an example, the memory system sends, to the host, data input UPIUs of the L2P mapping table #0, the L2P mapping table #1, and the L2P mapping table #2 respectively corresponding to the [region, subregion]#0, the [region, subregion]#1, and the [region, subregion]#2. It can be understood that, since the memory system may send at least two L2P mapping tables to the host at once, the number of interactions between the host and the memory system in the process of reading the L2P mapping table can be effectively reduced. That is, the number of times that the host sends the HPB read buffer command to the memory system and the number of times that the memory system sends the L2P mapping table to the host in response to the HPB read buffer command are reduced, such that the read efficiency is effectively improved.

In the examples of the present disclosure, the memory system may send, to the host, the L2P mapping table in the first operation mode or the second operation mode, such that the number of interactions between the host and the memory system in the process of reading the L2P mapping table is effectively reduced, so as to improve the efficiency of the host reading the L2P mapping table, thereby improving the random read performance of a system, reducing power consumption to a certain extent, and improving user experience.

In the examples of the present disclosure, before sending the data input UPIU in response to the HPB read buffer command, the method of operating a memory system further includes sending at least one piece of second recommendation information, where each piece of second recommendation information includes data information of at least one HPB region.

As shown in FIG. 4, before sending the data input UPIU in response to the HPB read buffer command, the memory system also needs to send a response of at least one piece of second recommendation information to the host, and each piece of second recommendation information includes the data information of the at least one HPB region. In an example, the memory system sequentially sends three pieces of second recommendation information to the host. The first piece of second recommendation information sent includes the data information of the [region, subregion]#0; the second piece of second recommendation information sent includes the data information of the [region, subregion]#1; and the third piece of second recommendation information sent includes the data information of the [region, subregion]#2.

In another example of the present disclosure, the memory system may send one piece of second recommendation information to the host, and the second recommendation information includes the data information of two HPB regions.

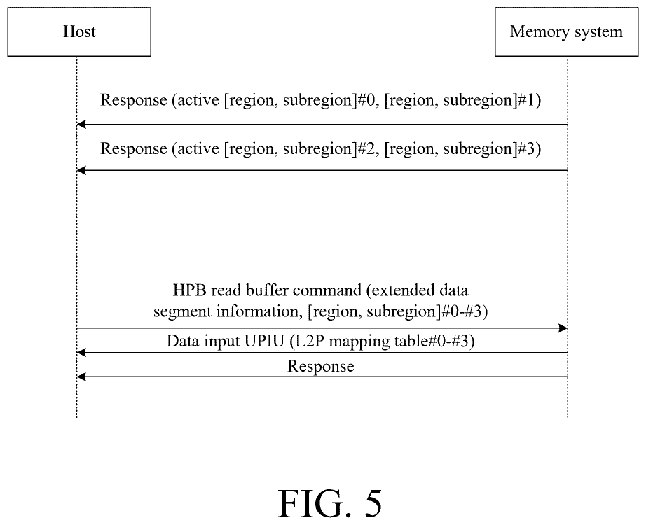

FIG. 5 is a schematic diagram of performing HPB data communication between a memory system and a host in a second operation mode in another example of the present disclosure.

As shown in FIG. 5, before sending the data input UPIU in response to the HPB read buffer command, the memory system sends two pieces of second recommendation information to the host. The first piece of second recommendation information sent includes the data information of the [region, subregion]#0 and the [region, subregion]#1; and the second piece of second recommendation information sent includes the data information of the [region, subregion]#2 and the [region, subregion]#3. Therefore, the efficiency of reading the L2P mapping table can be further improved, thereby improving a random read capability of the system.

In the examples of the present disclosure, as shown in FIG. 4, after the memory system sends the data input UPIU to the host, the memory system may also send response information configured to indicate completion of a read operation of the L2P mapping table.

In the examples of the present disclosure, the first recommendation information includes data information of at least one HPB region, and each HPB region corresponds to one L2P mapping table.

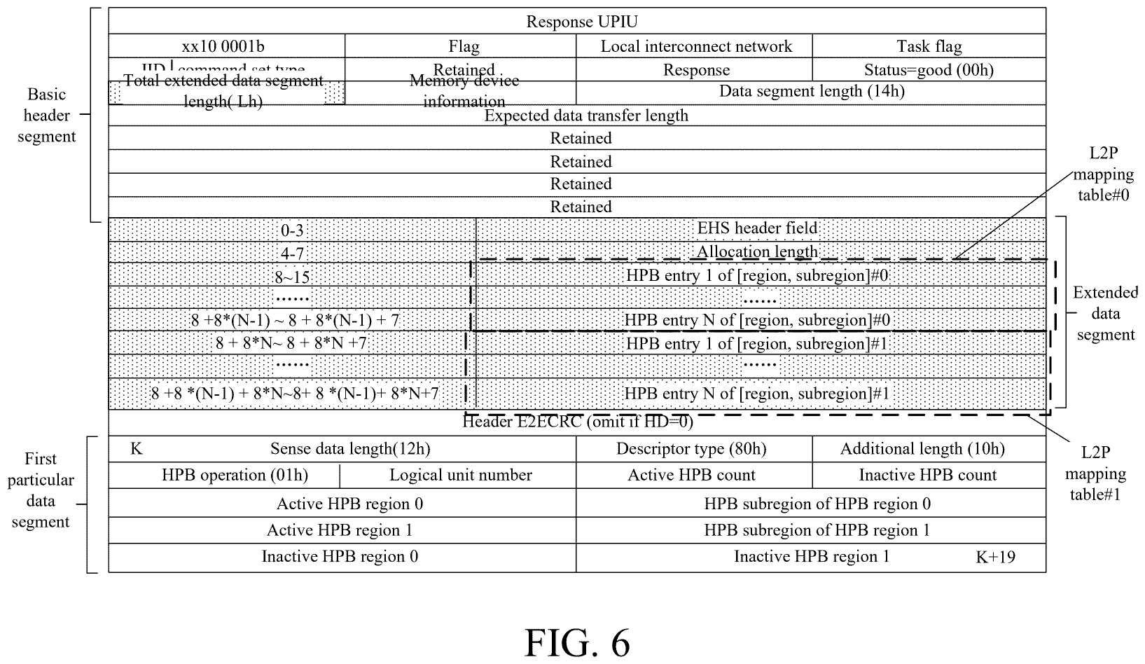

FIG. 6 is a UPIU format of first recommendation information provided by examples of the present disclosure.

As shown in FIG. 6, the memory system may transmit a response (Response UPIU) of the first recommendation information to the host through a UFS Protocol Information Unit (UPIU) packet. The first recommendation information includes data information of two active HPB regions (Action HPB Region+Subregion), and L2P mapping tables corresponding to the HPB regions. In an example, the active HPB region includes [region, subregion]#0 composed of an active HPB region 0 and an HPB subregion of the HPB region 0, and [region, subregion]#1 composed of an active HPB region 1 and an HPB subregion of the HPB region 1. Furthermore, the first recommendation information further includes an L2P mapping table #0 and an L2P mapping table #1 respectively corresponding to the [region, subregion]#0 and the [region, subregion]#1. Each L2P mapping table includes N HPB entries, and each HPB entry has 8 bytes of information.

In the examples of the present disclosure, that the first recommendation information includes the data information of the at least one HPB region means that the first recommendation information includes the data information of at least one active HPB region.

In the examples of the present disclosure, the first recommendation information includes an extended data segment and a first particular data segment, the extended data segment is configured to store the L2P mapping table, and the first particular data segment is configured to store the data information of the HPB region.

As shown in FIG. 6, the first recommendation information includes the extended data segment. Herein, the extended data segment may be an Extra Header Segment (EHS). The EHS may include an EHS header field and an EHS data field.

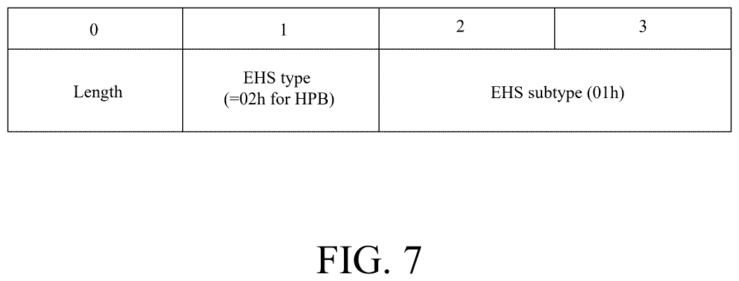

FIG. 7 is a format of an EHS header field provided by examples of the present disclosure.

In combination with FIGS. 6 and 7, the EHS header field occupies 0th to 3rd bytes of the EHS. The EHS header field includes a length (blength), an EHS type (bEHSType), and an EHS subtype (bEHSSubType). The length occupies the 0th byte of the EHS, the EHS type occupies the 1st byte of the EHS, and the EHS subtype occupies the 2nd to 3rd bytes of the EHS. Herein, a value of the EHS type may be set to a value defined by a user, for example, 02h, so as to cause the EHS type to distinguish from a current type, and the EHS may be configured to achieve an HPB function by defining the EHS type. A value of the EHS subtype may be set, for example, the value of the EHS subtype is set to 01h.

Continuously referring to FIG. 6, the EHS data field includes an allocation length (ALLOCATION LENGTH_1) and the L2P mapping table corresponding to the active HPB region. The allocation length occupies 4th to 7th bytes of the EHS, and the L2P mapping table occupies an 8th byte of the EHS and other bytes after the 8th byte. In an example, the EHS data field includes the L2P mapping table #0 and the L2P mapping table #1 respectively corresponding to the [region, subregion]#0 and the [region, subregion]#1. It can be understood that each HPB entry occupies 8 bytes, and one L2P mapping table has N HPB entries. Therefore, the L2P mapping table #0 occupies 8th to (8+8*(N−1)+7)th bytes of the EHS, and the L2P mapping table #1 occupies (8+8*N)th to (8+8*(N−1)+8*N+7)th bytes of the EHS.

In one example, a value of the allocation length of the EHS data field may be equal to a value of the length of the EHS header field.

As shown in FIG. 6, the first recommendation information may further include a basic header segment. The basic header segment occupies 32 bytes. In an example, a transaction type occupies a 0th byte of the basic header segment; and the transaction type may be a binary string, for example, “xx100001b”, which is configured to indicate that the transaction type is a response. A flag occupies a 1st byte of the basic header segment, and the flag may include a read flag indicating reading, a write flag indicating writing, an attribute flag indicating a task attribute of a command, and a priority flag indicating a command priority. A local interconnect network (LIN) occupies a 2nd byte of the basic header segment. A task tag occupies a 3rd byte of the basic header segment. An initiator ID (IID) and command set type occupies a 4th byte of the basic header segment. A 5th byte of the basic header segment may be retained. A response occupies a 6th byte of the basic header segment. A status occupies a 7th byte of the basic header segment, and a value of the status may be 00h and is configured to indicate that the response is good. A total extended data segment length (Total EHS length) occupies an 8th byte of the basic header segment, and a value of the total extended data segment length may be a hexadecimal value. A memory device information occupies a 9th byte of the basic header segment. A data segment length occupies 10th to 11th bytes of the basic header segment, where the 10th byte may store a most significant bit (MSB) of the data segment length, and the 11th byte may store a least significant bit (LSB) of the data segment length. The data segment length may be configured as a hexadecimal string, for example, “14h”. An expected data transfer length (Residual Transfer Count) occupies 12th to 15th bytes of the basic header segment. The 12th byte may store an MSB of the expected data transfer length, and the 15th byte may store an LSB of the expected data transfer length. The sixteenth to thirty-first bytes of the basic header segment may be retained.

Referring to FIG. 6, a first particular data segment occupies 20 bytes, i.e., occupying the kth to (K+19)th bytes. A sense data length occupies the kth to (K+1)th bytes, and a value of the sense data length may be 12h. A descriptor type occupies the (K+2)th byte, and a value of the descriptor type may be 80h. An additional length occupies the (K+3)th byte, and a value of the additional length may be 10h. An HPB operation occupies the (K+4)th byte, and a value of the HPB operation may be 01h and used to indicate a request for HPB region update. A logical unit number (LUN) occupies the (K+5)th byte. An active HPB count occupies the (K+6)th byte. An inactive HPB count occupies the (K+7)th byte. Data information of an active HPB region occupies the (K+8)th to (K+15)th bytes. Data information of an inactive HPB region occupies the (K+16)th to (K+19)th bytes.

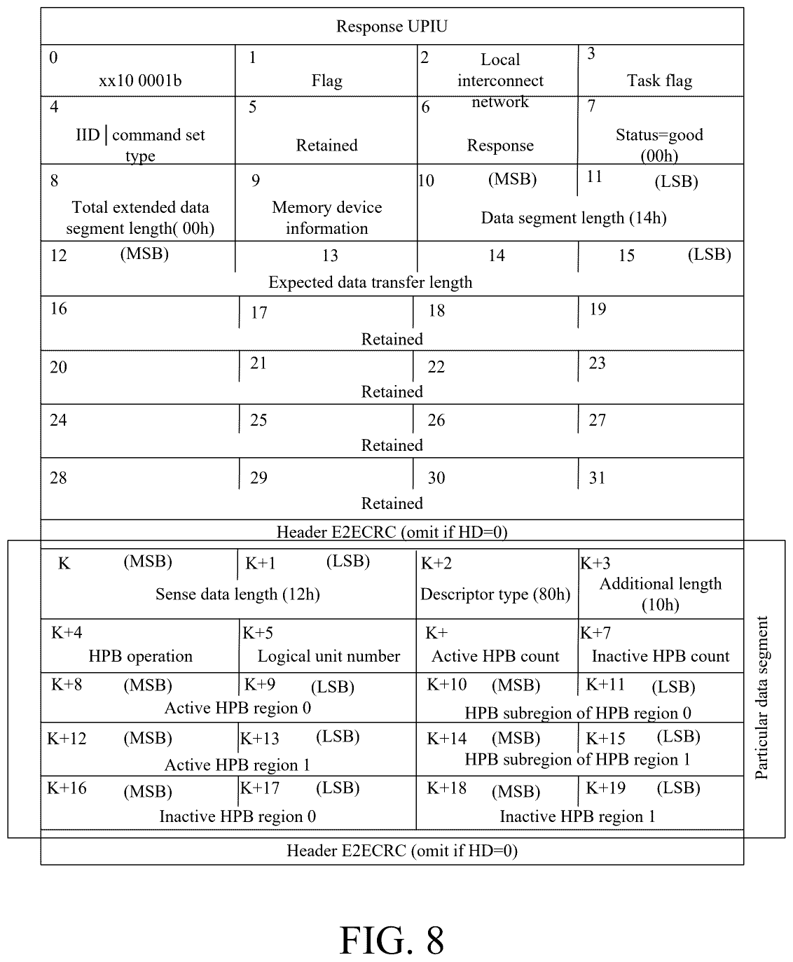

FIG. 8 is a UPIU format of recommendation information provided in one example.

As shown in FIG. 8, the recommendation information includes a basic header segment similar to that in FIG. 6, and a particular data segment (Sense Data). The particular data segment may be configured to store the data information of the active HPB region. In an example, the data information of the [region, subregion]#0 and the [region, subregion]#1 is stored. The memory system may send the data information of the active HPB region to the host through the recommendation information. However, since the particular data segment only includes 20 bytes, the particular data segment is unable to include the L2P mapping table corresponding to the active HPB region. That is, the memory system in the examples is unable to send the L2P mapping table to the host through the recommendation information. In this way, the host needs to send the HPB read buffer command to the memory system, and the memory system sends the L2P mapping table to the host after responding to the HPB read buffer command. Therefore, the low random read performance of the system is realized.

Continuously referring to FIG. 6, the first recommendation information provided by the examples of the present disclosure include an extended data segment (i.e., EHS), and since a size of the EHS may change, the EHS may include more bytes. For example, the number of bytes included in the EHS may be far beyond 20, so as to cause the EHS to be able to be configured to store at least one L2P mapping table. Therefore, the memory system in the examples of the present disclosure may send the L2P mapping table to the host through the first recommendation information, thereby effectively improving read efficiency.

In the examples of the present disclosure, the extended data segment includes an allocation length, the first recommendation information further includes a total extended data segment length, the allocation length is related to the total extended data segment length, and the total extended data segment length is related to the number of the HPB regions.

In the examples of the present disclosure, within the extended data segment in the first recommendation information, a calculation formula of the allocation length is as follows,

$$allocation length = N \times size of HPB entry \times k$$

where k is equal to 1 or 2, which is configured to indicate that the extended data segment may include 1 or 2 L2P mapping tables. Each L2P mapping table corresponds to one HPB region. The size of the HPB entry may be 8 bytes. A calculation formula of N is as follows,

$$N = size of HPB subregion \div size of read information block .$$

Herein, the size of the read information block may be 4 bytes. In one example, the size of the HPB subregion may be 4K bytes.

It can be understood that the extended data segment includes k L2P mapping tables, each L2P mapping table has N HPB entries, and each HPB entry includes 8 bytes. Thus, the L2P mapping tables of the extended data segment occupy k×N×8 bytes. Moreover, the EHS header field and the allocation length of the extended data segment occupy 8 bytes in total. Furthermore, For each 32 bytes being included in the extended data segment, the value of the total extended data segment length of the basic header segment corresponding to the first recommendation information needs to be increased by 1.

Thus, in the first recommendation information, a calculation formula of the total extended data segment length of the basic header segment of the first recommendation information is as follows,

$$total extended data segment length = ( k \times N \times 8 + 8 ) \div 32 + 1 .$$

In the examples of the present disclosure, the total extended data segment length is taken as an integer.

From the above, it can be learned that the allocation length in the extended data segment of the first recommendation information is related to the total extended data segment length of the basic header segment of the first recommendation information, and the total extended data segment length is related to the number of HPB regions in the first particular data segment.

In the examples of the present disclosure, the data input UPIU includes data information of at least two HPB regions, and each HPB region corresponds to one L2P mapping table.

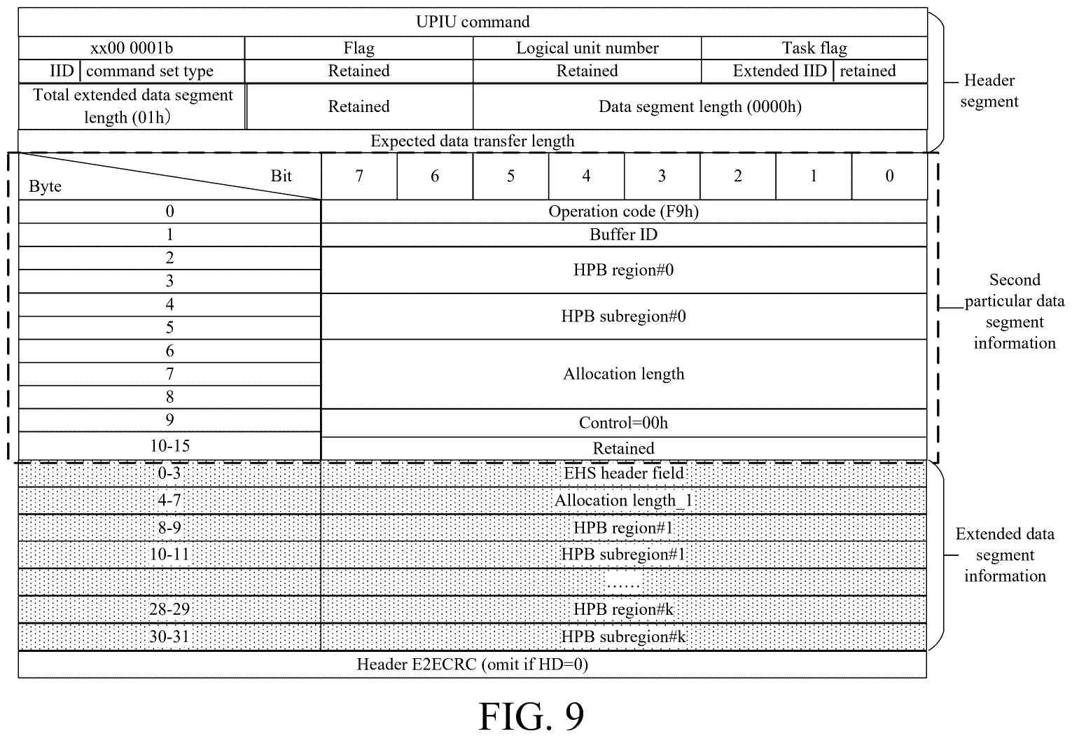

FIG. 9 is a UPIU format of an HPB read buffer command provided by examples of the present disclosure.

As shown in FIG. 9, the UPIU format of the HPB read buffer command includes a header segment, second particular data segment information, and extended data segment information (EHS Filed). The second particular data segment information is a CDB format (as shown in a rectangular dash box) of the HPB read buffer command. A 0th byte of the header segment stores a transaction type, and the transaction type is a binary string, for example, “xx000001b”, which is configured to indicate that the transaction type is a command. An 8th byte of the header segment stores the total extended data segment length (Total EHS Length).

The second particular data segment information occupies 16 bytes. An operation code occupies the 0th byte. The operation code may be a hexadecimal number, for example, F9h, which is used to indicate the performing of the HPB read buffer command. A buffer ID occupies a 1st byte. The buffer ID may be a retained 00h or 01h read L2P mapping table, retained other items, etc. A most significant bit (MSB) to a least significant bit (LSB) of an HPB region #0 occupy the 2nd to 3rd bytes. A most significant bit (MSB) to a least significant bit (LSB) of an HPB subregion #0 occupy the 4th to 5th bytes. The allocation length occupies the 6th to 8th bytes. A control occupies the 9th byte, and the control may be a hexadecimal character, for example, 00h. The 10th to 15th bytes may be retained. In FIG. 9, the CDB format of the HPB read buffer command includes data information of one HPB region.

The extended data segment information occupies 32 bytes, and the extended data segment information may be an extra header segment (i.e., EHS). The EHS may include an EHS header field and an EHS data field. The EHS header field occupies the 0th to 3rd bytes of the EHS. Referring to FIG. 7, the EHS header field includes the length information, the EHS type, and the EHS subtype. The length information occupies the 0th byte of the EHS, the EHS type occupies the 1st byte of the EHS, and the EHS subtype occupies the 2nd to 3rd bytes of the EHS. Herein, the value of the EHS type may be set to the value defined by the user, for example, 02h, so as to cause the EHS type to distinguish from the current type, and the EHS may achieve the HPB function by defining the EHS type. The value of the EHS subtype may be set, for example, the value of the EHS subtype is set to 00h.

Referring to FIG. 9, in the EHS data field, an allocation length_1 occupies the 4th to 7th bytes of the EHS, and the data information of the HPB region occupies the 8th to 31st bytes of the EHS. In an example, the [region, subregion]#1 to the [region, subregion]#k occupy the 8th to 31st bytes of the EHS, where k may be greater than or equal to 1. When k is equal to 1, the EHS data field includes the data information of one HPB region. That is, the UPIU format of the HPB read buffer command includes the data information of two HPB regions. It can be understood that the memory system subsequently sends the L2P mapping table to the host in a manner of the data input UPIU; the data input UPIU also includes the data information of two HPB regions; and each HPB region corresponds to one L2P mapping table.

It is to be noted that, since the extended data segment information occupies 32 bytes, the value of the total extended data segment length is 01h.

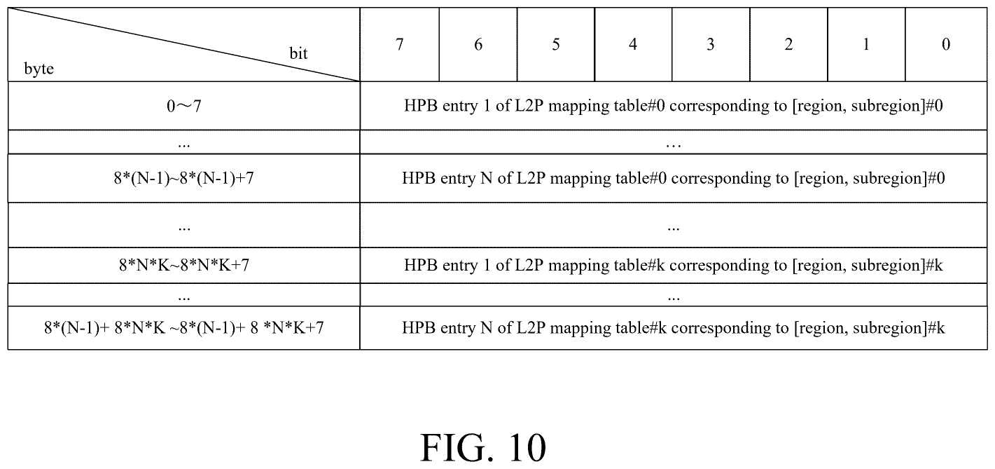

FIG. 10 is an L2P mapping table in a data input UPIU provided by examples of the present disclosure.

As shown in FIG. 10, there are k+1 L2P mapping tables in the data input UPIU in total, and each L2P mapping table has N HPB entries. Furthermore, the k+1 L2P mapping tables occupy 8×N+8×N×k bytes. Herein, k is greater than or equal to 1. In combination with FIGS. 9 and 10, the data input UPIU includes L2P mapping tables corresponding to k+1 HPB regions, i.e., the L2P mapping table #0 to the L2P mapping table #k. In an example, when k is equal to 1, the data input UPIU includes the L2P mapping tables corresponding to two HPB regions. In an example, the data input UPIU includes the L2P mapping table #0 and the L2P mapping table #1 respectively corresponding to the [region, subregion]#0 and the [region, subregion]#1.

In the examples of the present disclosure, the data input UPIU includes extended data segment information and second particular data segment information; the second particular data segment information is configured to store data information of the first one among the at least two HPB regions; and the extended data segment information is configured to store data information of the HPB regions other than the first HPB region.

Referring to FIG. 9, the second particular data segment information is configured to store the data information of the first one among at least two HPB regions; and in an example, the second particular data segment information is configured to store the data information of the [region, subregion]#0. The extended data segment information is configured to store the data information of other HPB regions other than the first HPB region; and in an example, the extended data segment information is configured to store the data information of the [region, subregion]#1 to the [region, subregion]#k.

In the examples of the present disclosure, the extended data segment information includes the allocation length (i.e., the allocation length_1), the data input UPIU further includes the total extended data segment length, the allocation length is related to the total extended data segment length, and the total extended data segment length is related to the number of the HPB regions.

In the examples of the present disclosure, in the extended data segment information of the data input UPIU, the allocation length_1 may be calculated with reference to the calculation formula of the allocation length in the first recommendation information. However, it is to be noted that, herein, a range of a k value in the calculation formula of the allocation length_1 in the data input UPIU is reset. That is, k is set to a positive integer.

In the examples of the present disclosure, the total extended data segment length occupies the 8th byte of the header segment of the data input UPIU, herein, the data input UPIU includes values of total extended data segment lengths of different header segments corresponding to different extended data segment information. In an example, referring to FIG. 8, if the data input UPIU does not include the extended data segment information, the value of the total extended data segment length of the header segment is 00h. When the extended data segment information in the data input UPIU includes 1 to 32 bytes, the value of the total extended data segment length of the header segment may be greater than or equal to 01h. In an example, referring to FIG. 9, the extended data segment information in the data input UPIU includes 32 bytes, in this case, the value of the total extended data segment length of the header segment is equal to 01h. In other examples, when the extended data segment information in the data input UPIU includes 33 to 64 bytes, the value of the total extended data segment length of the header segment may be equal to 02h.

It is to be noted that, a value of the number k of the HPB regions is related to the total extended data segment length of the header segment. When the total extended data segment length is determined, a value range of k is as follows.

When the value of the total extended data segment length is equal to 01h, 0<k≤((32−8)/4);
when the value of the total extended data segment length is equal to 02h, 0<k≤[((32−8)/4)+32/4];
when the value of the total extended data segment length is equal to 03h, 0<k≤[((32−8)/4)+32/4×2];
in an example, when the value of the total extended data segment length of the header segment is equal to 03h, the maximum value of k may be 22. In this case, the data input UPIU includes the data information of up to 23 HPB regions.

Since k is related to the number of the HPB regions, and k is related to the allocation length_1, the allocation length_1 of the extended data segment information is related to the total extended data segment length of the header segment, and the total extended data segment length of the header segment is related to the number of the HPB regions in the data input UPIU.

In the examples of the present disclosure, sending the L2P mapping table in the first operation mode or the second operation mode includes acquiring an internal storage situation of a target device; and determining to send the L2P mapping table in the first operation mode or the second operation mode according to the acquired internal storage situation of the target device.

In the examples of the present disclosure, the target device may be a host. The memory system may determine, according to the acquired internal storage situation of the target device, to send, to the host, the L2P mapping table in the first operation mode or the second operation mode. Therefore, the host may acquire the L2P mapping table more flexibly.

In the examples of the present disclosure, determining to send the L2P mapping table in the first operation mode or the second operation mode according to the acquired internal storage situation of the target device includes, when an internal storage usage of the target device is greater than a first threshold, sending the L2P mapping table in the first operation mode; and when the internal storage usage of the target device is less than or equal to the first threshold, sending the L2P mapping table in the second operation mode.

In the examples of the present disclosure, the memory system may send 1 to 2 L2P mapping tables to the host in the first operation mode, and may send more than 2 L2P mapping tables to the host in the second operation mode. Thus, when an internal storage usage of the host is greater than the first threshold, i.e., when the host has less internal storage available, the memory system may send, to the host, the L2P mapping table in the first operation mode. When the internal storage usage of the host is less than or equal to the first threshold, i.e., when the host has more internal storage available, the memory system may send, to the host, the L2P mapping table in the second operation mode. The first threshold may be set based on an internal storage usage situation of each L2P mapping table. Therefore, the memory system is prevented from still continuously sending a large number of L2P mapping tables to the host when the host has less internal storage available, resulting in a situation where the host is unable to acquire all the L2P mapping tables.

Examples of the present disclosure provide a method of operating a host. The method of operating a host may include receiving at least one piece of first recommendation information or second recommendation information. The method of operating a host may include, when receiving the first recommendation information, decoding the first recommendation information to obtain at least one L2P mapping table. The method of operating a host may include, when receiving the second recommendation information, sending an HPB read buffer command. The HPB read buffer command includes data information of at least two HPB regions.

As shown in FIG. 3, the host receives a response of one piece of first recommendation information sent by the memory system, and the first recommendation information includes at least one L2P mapping table, for example, an L2P mapping table #0. When receiving the first recommendation information, the host may decode the first recommendation information to obtain the L2P mapping table #0.

As shown in FIG. 4, the host receives responses of three pieces of second recommendation information sent by the memory system, and each piece of second recommendation information includes the data information of one HPB region. In an example, the first piece of second recommendation information includes the data information of the [region, subregion]#0; the second piece of second recommendation information includes the data information of the [region, subregion]#1; and the third piece of second recommendation information includes the data information of the [region, subregion]#2. After receiving the three pieces of second recommendation information, the host sends the HPB read buffer command to the memory system, and in this case, the HPB read buffer command also includes data information of [region, subregion]#0, [region, subregion]#1, and [region, subregion]#2.

In the examples of the present disclosure, after sending the HPB read buffer command, the method of operating a host further includes receiving a data input UPIU sent by a target device in response to the HPB read buffer command. In the examples of the present disclosure, after sending the HPB read buffer command, the method of operating a host further includes decoding the data input UPIU to obtain at least two L2P mapping tables, where each L2P mapping table corresponds one HPB region.

In the examples of the present disclosure, the target device of the host may be a memory system.

As shown in FIG. 4, the host receives the data input UPIU sent by the memory system in response to the HPB read buffer command. The data input UPIU includes three L2P mapping tables, which respectively are the L2P mapping table #0, an L2P mapping table #1, and an L2P mapping table #2. The L2P mapping table #0 corresponds to the [region, subregion]#0, the L2P mapping table #1 corresponds to the [region, subregion]#1, and the L2P mapping table #2 corresponds to the [region, subregion]#2. The host may obtain the three L2P mapping tables by decoding the data input UPIU.

In the examples of the present disclosure, the HPB read buffer command includes extended data segment information and second particular data segment information; the second particular data segment information is configured to store data information of the first one among the at least two HPB regions; and the extended data segment information is configured to store data information of the HPB regions other than the first HPB region.

As shown in FIG. 9, the second particular data segment information is configured to store the data information of the [region, subregion]#0, and the extended data segment information is configured to store the data information of the [region, subregion]#1 to the [region, subregion]#k.

In the examples of the present disclosure, the extended data segment information includes an allocation length, and the allocation length is related to the number of the HPB regions.

In the examples of the present disclosure, before receiving at least one piece of first recommendation information or second recommendation information, the method of operating a host further includes sending an internal storage situation to the target device.

In the examples of the present disclosure, the host may send an internal storage situation of its own to the memory system. After receiving the internal storage situation of the host, the memory system may determine, according to the internal storage situation, to send, to the host, the L2P mapping table in the first operation mode or the second operation mode.

Examples of the present disclosure provide a memory system. The memory system may include a memory device and a controller, where the controller is configured to perform the operation method of a memory system in the above-mentioned examples.

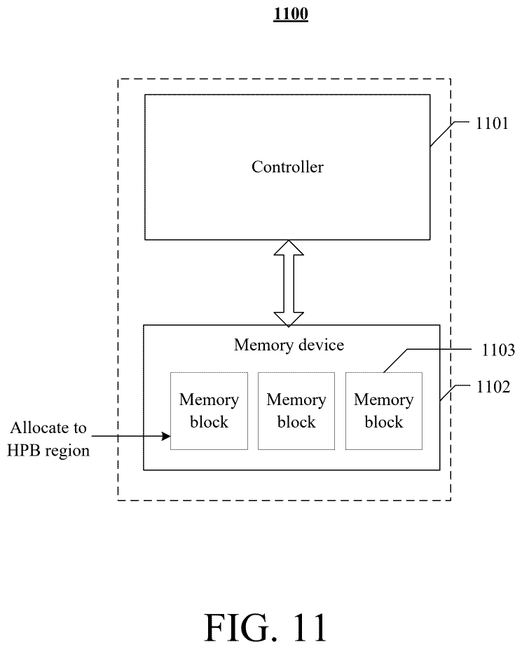

FIG. 11 is a block diagram of a memory system provided by examples of the present disclosure.

As shown in FIG. 11, the memory system 1100 includes a controller 1101 and a memory device 1102, where the memory device 1102 includes a plurality of memory blocks 1103, and each memory block 1103 includes a plurality of memory cells. At least one of the plurality of memory blocks 1103 in the memory device 1102 is allocated to an HPB region, and the HPB region refers to a logical memory space in which the memory block 1103 in the memory device 1102 is functionally assigned or allocated. The HPB region may include a memory space in which a data item corresponding to mapping information transmitted from the memory system 1100 to the host is stored. The HPB region may also be further divided into a plurality of HPB subregions. The controller 1101 may transmit, to the host, the mapping information with respect to the data item in the corresponding memory block 1103 that is designed as the HPB region.

The memory device 1102 performs operations under the control of the controller 1101. The memory device 1102 includes a memory cell array having the plurality of memory blocks 1103. In some examples, the memory device 1102 may be a NAND memory.

The controller 1101 may receive a write command, a read command, etc. of data from the host, and control the memory device 1102 based on the received commands. In an example, the controller 1101 may generate a command for controlling operations of the memory device 1102, and transmit the command to the memory device 1102.

The memory device 1102 is configured to receive commands and addresses from the controller 1101, and access regions in the memory cell array that are selected by the addresses. That is to say, the memory device 1102 performs internal operations corresponding to the commands on the regions selected by the addresses.

Examples of the present disclosure provide a host. The host may be configured to perform the method of operating the host in the above-mentioned examples.

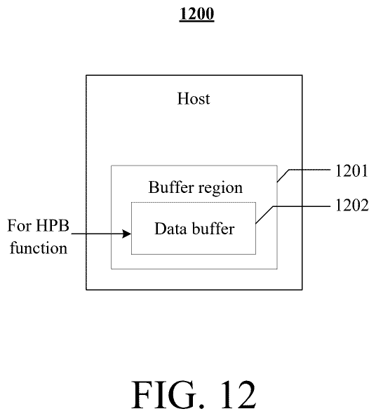

FIG. 12 is a block diagram of a host provided by examples of the present disclosure.

As shown in FIG. 12, the host 1200 may include a buffer region 1201, and at least part of the buffer region 1201 may include a data buffer 1202 for an HPB function. The HPB function refers to a function of caching at least part of an L2P mapping table in a memory system, which is configured to maintain a relationship between a logical address and a physical address, in the data buffer 1202 of the host 1200 and using the L2P mapping table. In order to improve random read performance, during command reading or other memory operations, the L2P mapping table is stored in the data buffer 1202 of the host 1200. Therefore, when accessing the memory system, the host 1200 may achieve quick access by reading the L2P mapping table in the data buffer 1202 of the host 1200.

The host 1200 may include any one of the following various electronic devices: portable electronic devices such as mobile phones, MP3 players, and laptop computers, or non-portable electronic devices of desktop computers, games consoles, TVs, and projectors, i.e., wireless or wired electronic devices. Furthermore, the host 1200 includes at least one operating system; and the operating system generally manages and controls functions and operations of the host 1200, and uses the memory system to provide an interaction between the host 1200 and a user. Herein, the operating system may support functions and operations corresponding to usage objects and objectives of the user. For example, according to the mobility of the host 1200, the operating system may be classified into a general operating system and a mobile operating system. Furthermore, according to a usage environment of the user, the general operating system in the operating system may be classified into a personal operating system and an enterprise operating system. For example, the personal operating system may support a service providing function of an ordinary user, and include windows, Chrome, etc. The enterprise operating system may ensure and support high performance, and include a Windows server, Linux, Unix, etc. Furthermore, the mobile operating system in the operating system may provide functions and power-saving functions for mobility services of a user-supporting system, and include Android, IOS, Windows Mobile, HarmonyOS, etc. The host 1200 may include the plurality of operating systems, and operate the operating systems to utilize the memory system to perform operations corresponding to user requests. Herein, the host 1200 transmits a plurality of commands corresponding to the user requests to the memory system, such that the memory system performs operations corresponding to the commands, i.e., the operations corresponding to the user requests.

Examples of the present disclosure provide a data processing system. The data processing system may include a memory system and a host. The memory system may be configured to send, to the host, an L2P mapping table in a first operation mode or a second operation mode. The memory system may be configured to, in the first operation mode, the memory system is configured to send first recommendation information to the host, where the first recommendation information includes at least one L2P mapping table. The memory system may be configured to, in the second operation mode, the memory system is configured to send a data input UPIU to the host in response to an HPB read buffer command sent by the host, where the data input UPIU includes at least two L2P mapping tables.

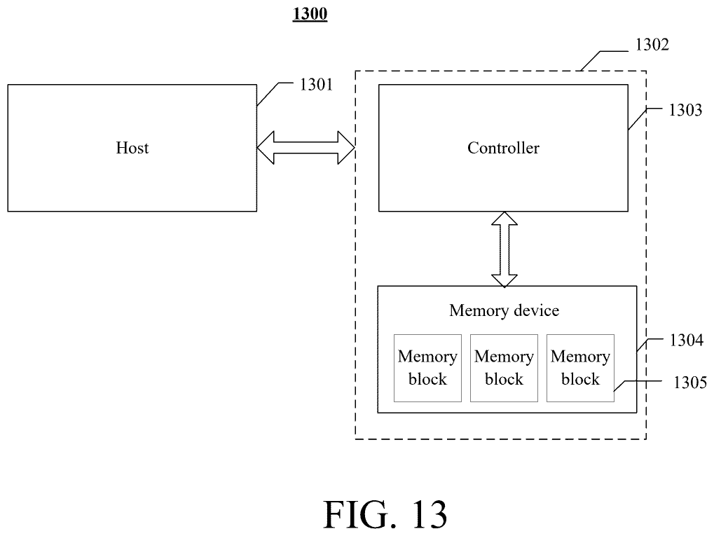

FIG. 13 is a block diagram of a data processing system provided by examples of the present disclosure.

As shown in FIG. 13, the data processing system 1300 may include a host 1301, and the host 1301 may be bonded to or coupled with a memory system 1302. For example, the host 1301 and the memory system 1302 may be coupled with each other via a data bus, a host cable, etc., so as to perform a data communication.

The memory system 1302 includes a controller 1303 and a memory device 1304, and at least one memory block 1305 in the memory device 1304 may be allocated to an HPB region. When an L2P mapping table is transmitted to the host 1301, a speed of the host 1301 reading a read operation of a data item corresponding to the L2P mapping table may be accelerated.

In the examples of the present disclosure, the memory system is further configured to send at least one piece of second recommendation information to the host; and each piece of second recommendation information includes data information of at least one HPB region.

In the examples of the present disclosure, the host may be configured to, when receiving the first recommendation information, decode the first recommendation information to obtain at least one L2P mapping table. The host may be configured to, when receiving the second recommendation information, send an HPB read buffer command to the memory system, where the HPB read buffer command includes data information of at least two HPB regions.

In the examples of the present disclosure, the host is further configured to send an internal storage situation to the memory system; and the memory system is further configured to determine, according to the internal storage situation, to send, to the host, the L2P mapping table in the first operation mode or the second operation mode.

The examples of the present disclosure provide the memory system, the host, the operation method, and the data processing system. The operation method of a memory system includes: sending a logical-to-physical (L2P) mapping table in a first operation mode or a second operation mode, where the first operation mode includes: sending first recommendation information, where the first recommendation information includes at least one L2P mapping table; and the second operation mode includes: sending a data input universal flash storage protocol information unit (UPIU) in response to a host performance booster (HPB) read buffer command, where the data input UPIU includes at least two L2P mapping tables. In the examples of the present disclosure, the memory system send the L2P mapping table in the first operation mode or the second operation mode, where in the first operation mode, the memory system directly sends the recommendation information including the L2P mapping table to the host, such that the host may save an operation of sending the HPB read buffer command to the memory system, thereby reducing the number of data interactions between the memory system and the host. In the second operation mode, the memory system sends, in response to the HPB read buffer command, the data input UPIU including at least two L2P mapping tables to the host, such that the number of data interactions between the memory system and the host is also reduced. Therefore, by means of the operation method of a memory system provided by the examples of the present disclosure, the read efficiency of the L2P mapping table is effectively improved, such that the random read performance is enhanced, and the user experience is improved.

It is to be understood that “one example” and “an example” mentioned throughout the specification mean that specific features, structures or characteristics related to the example are included in at least one example of the present disclosure. Therefore, “in one example” or “in an example” presented everywhere throughout this specification does not necessarily refer to the same example. In addition, these specific features, structures or characteristics may be combined in one or more examples in any proper manner. It is to be understood that, in various examples of the present disclosure, sequence numbers of the above processes do not indicate an execution sequence, and an execution sequence of various processes shall be determined by functionalities and intrinsic logics thereof, and shall constitute no limitation on an implementation process of the examples of the present disclosure. The above sequence numbers of the examples of the present disclosure are only for description, and do not represent goodness and badness of the examples.

The above descriptions are merely preferred implementations of the present disclosure, and not intended to limit the scope of the present disclosure. Equivalent structure transformation made within using the contents of the specification and the drawings of the present disclosure under the inventive concept of the present disclosure, or direct/indirect application to other related technical fields are both encompassed within the protection scope of the present disclosure.

What is claimed is:

1. A method of operating a memory system, comprising:
sending a logical-to-physical (L2P) mapping table in a first operation mode or a second operation mode, wherein
the first operation mode comprises: sending first recommendation information, wherein the first recommendation information comprises at least one L2P mapping table; and
the second operation mode comprises: sending a data input universal flash storage protocol information unit (UPIU) in response to a host performance booster (HPB) read buffer command, wherein the data input UPIU comprises at least two L2P mapping tables.

2. The method of claim 1, wherein the first recommendation information comprises data information of at least one HPB region, and each HPB region corresponds to one L2P mapping table.

3. The method of claim 2, wherein the first recommendation information comprises an extended data segment and a first particular data segment, the extended data segment is configured to store the L2P mapping table, and the first particular data segment is configured to store the data information of the HPB region.

4. The method of claim 3, wherein the extended data segment comprises an allocation length, the first recommendation information further comprises a total extended data segment length, the allocation length is related to the total extended data segment length, and the total extended data segment length is related to a number of the HPB regions.

5. The method of claim 1, wherein the data input UPIU comprises data information of at least two HPB regions, and each HPB region corresponds to one L2P mapping table.

6. The method of claim 5, wherein the data input UPIU comprises extended data segment information and second particular data segment information; the second particular data segment information is configured to store data information of the first one among the at least two HPB regions; and the extended data segment information is configured to store data information of the HPB regions other than a first HPB region.

7. The method of claim 6, wherein the extended data segment information comprises an allocation length, the data input UPIU further comprises a total extended data segment length, the allocation length is related to the total extended data segment length, and the total extended data segment length is related to a number of the HPB regions.

8. The method of claim 1, wherein before the sending the data input UPIU in response to the HPB read buffer command, the method further comprises:
sending at least one piece of second recommendation information, wherein each piece of second recommendation information comprises data information of at least one HPB region.

9. The method of claim 1, wherein the sending the L2P mapping table in the first operation mode or the second operation mode comprises:
acquiring an internal storage situation of a target device; and
determining to send the L2P mapping table in the first operation mode or the second operation mode according to the acquired internal storage situation of the target device.

10. The method of claim 9, wherein the determining to send the L2P mapping table in the first operation mode or the second operation mode according to the acquired internal storage situation of the target device comprises:
when an internal storage usage of the target device is greater than a first threshold, sending the L2P mapping table in the first operation mode; and
when the internal storage usage of the target device is less than or equal to the first threshold, sending the L2P mapping table in the second operation mode.

11. A method of operating a host, comprising:
receiving at least one piece of first recommendation information or second recommendation information;
when receiving the first recommendation information, decoding the first recommendation information to obtain at least one L2P mapping table; and
when receiving the second recommendation information, sending an HPB read buffer command, wherein the HPB read buffer command comprises data information of at least two HPB regions.

12. The method of claim 11, wherein after the sending the HPB read buffer command, the method further comprises:
receiving a data input UPIU sent by a target device in response to the HPB read buffer command; and
decoding the data input UPIU to obtain at least two L2P mapping tables, wherein each L2P mapping table corresponds to one HPB region.

13. The method of claim 11, wherein the HPB read buffer command comprises extended data segment information and second particular data segment information; the second particular data segment information is configured to store data information of the first one among the at least two HPB regions; and the extended data segment information is configured to store data information of the HPB regions other than a first HPB region.

14. The method of claim 13, wherein the extended data segment information comprises an allocation length, and the allocation length is related to a number of the HPB regions.

15. The method of claim 11, wherein before receiving at least one piece of the first recommendation information or the second recommendation information, the method further comprises:
sending an internal storage situation to a target device.

16. A memory system, comprising:
a memory device and a controller, wherein the controller is configured to perform a method of operating a memory system comprising:
sending a logical-to-physical (L2P) mapping table in a first operation mode or a second operation mode, wherein
the first operation mode comprises: sending first recommendation information, wherein the first recommendation information comprises at least one L2P mapping table; and
the second operation mode comprises: sending a data input universal flash storage protocol information unit (UPIU) in response to a host performance booster (HPB) read buffer command, wherein the data input UPIU comprises at least two L2P mapping tables.

17. The memory system of claim 16, wherein the first recommendation information comprises data information of at least one HPB region, and each HPB region corresponds to one L2P mapping table.

18. The memory system of claim 17, wherein the first recommendation information comprises an extended data segment and a first particular data segment, the extended data segment is configured to store the L2P mapping table, and the first particular data segment is configured to store the data information of the HPB region.

19. The memory system of claim 18, wherein the extended data segment comprises an allocation length, the first recommendation information further comprises a total extended data segment length, the allocation length is related to the total extended data segment length, and the total extended data segment length is related to a number of the HPB regions.

20. The memory system of claim 16, wherein the data input UPIU comprises data information of at least two HPB regions, and each HPB region corresponds to one L2P mapping table.
